(19) United States
(12) Patent Application Publication
(10) Pub. No.: US 2015/0050821 A1
(43) Pub. Date: Feb. 19, 2015

(54) CONNECTOR

(71) Applicant: SAMSUNG ELECTRONICS CO., LTD., Suwon-si (KR)

(72) Inventors: Hee-jo KIM, Yongin-si (KR); Se-hyun LEE, Anyang-si (KR)

(73) Assignee: SAMSUNG Electronics Co., Ltd., Suwon-si (KR)

(21) Appl. No.: 14/320,713

(22) Filed: Jul. 1, 2014

Related U.S. Application Data
(60) Provisional application No. 61/865,693, filed on Aug. 14, 2013.

(30) Foreign Application Priority Data
Dec. 23, 2013 (KR) 10-2013-0161092

(51) Int. Cl. H01R 12/55; H01R 4/02

(52) U.S. Cl. CPC H01R 12/55; H01R 4/021
USPC 439/83

(57) ABSTRACT

A connector includes a connector main body mounted on a printed circuit board (PCB), a plurality of pins provided in the connector main body and vertically arranged in at least two columns, and a connector cover configured to fix the connector main body to the PCB and have a pin expose hole configured to expose soldering portions of pins in at least one column among the plurality of pins.

### CROSS-REFERENCE TO RELATED APPLICATIONS

This application claims priority under 35 U.S.C. §119 from U.S. Provisional Patent Application No. 61/865,693, filed on Aug. 14, 2013, in the United States Patent and Trademark Office, and Korean Patent Application No. 10-2013-0161092, filed on Dec. 23, 2013, in the Korean Intellectual Property Office, the disclosures of which are incorporated herein by reference in their entirety.

### BACKGROUND OF THE INVENTION

1. Field of the Invention

Apparatuses and methods consistent with exemplary embodiments relate to a connector mounted on a circuit board, and more particularly, to a connector usable as a surface mounted device (SMD) type connector.

2. Description of the Related Art

In general, connectors used in printed circuit boards (PCBs) are divided into an SMD type connector and a through hole device (THD) type connector. A plurality of pins provided in the SMD type connectors are soldered on the PCB, and a plurality of pins provided in the THD type connectors penetrate the PCB. The SMD type connectors are advantageous in terms of cost and time as compared to the THD type connectors. Thus, various parts (for example, connectors) mounted on the PCB are typically the SMD type connectors.

In the SMD type connector, pins soldered to the PCB are arranged in a row along a width direction of the connector. Thus, when the number of pins is increased, a size of the connector in the width direction may be increased. The increase in the size of the connector having the plurality of pins may be solved by vertically arranging the plurality of pins in plural columns.

However, in the connectors, when plugs connected to the connectors are repeatedly mounted or detached, a load is transferred to the pins, and thus cracks occur in the pins.

Further, since only a portion of pins arranged in a portion of plural columns are exposed from a rear side surface of the connector and another portion of the pins are not exposed when the connector is mounted on the PCB, it is difficult to check soldering failures or the like to be caused later in the pins which are not arranged on (not exposed from) the rear side surface of the connector. In addition, soldering cannot be removed from the non-exposed pins without a process of detaching the connector from the PCB, and thus the non-exposed pins may cause replacement of the connector with a new connector.

### SUMMARY OF THE INVENTION

The present general inventive concept provide a connector to prevent a pin crack thereof, to easily check or fix a pin failure, to easily remove soldering from a pin of the connector and/or to easily replace the connector with a new one.

Additional features and utilities of the present general inventive concept will be set forth in part in the description which follows and, in part, will be obvious from the description, or may be learned by practice of the general inventive concept

The foregoing and/or other features and utilities of the present general inventive concept may be achieved by providing a connector. The connector may include a connector main body mounted on a printed circuit board (PCB), a plurality of pins provided in the connector main body and vertically arranged in at least two columns, and a connector cover configured to fix the connector main body to the PCB and have a pin expose hole configured to expose a soldering portion of pins arranged in at least one column among the plurality of pins.

The plurality of pins may include lower pins of which soldering portions are exposed through the pin expose hole and upper pins arranged at an upper side of the lower pins.

The upper pins may have soldering portions to be exposed from a rear side of the connector cover.

The plurality of pins may include upper pins of which soldering portions are exposed through the pin expose hole and lower pins arranged at a lower side of the upper pins.

The lower pins may have soldering portions to be exposed from a rear of the connector cover.

The connector main body may include a through hole formed thereon to be arranged in a lower side of the pin expose hole to expose the soldering portions of the pins in the at least one column among the plurality of pins and to penetrate the connector main body.

The connector cover may include a plurality of cover soldering portions to be soldered to the PCB.

The plurality of cover soldering portions may include a pair of rear end soldering portions provided in both side portions of a rear end portion of the connector cover, and a pair of side end soldering portions spaced apart from the pair of rear end soldering portions to a front of the connector cover and provided in both side portions of the connector cover.

The pair of side end soldering portions may protrude along a width direction of the connector cover, and protrude in the width direction of the connector cover rather than the pair of rear end soldering portions.

The pins may be alternately arranged in different columns along a width direction of the connector main body.

The connector may be a surface mounted device (SMD) type connector.

The foregoing and/or other features and utilities of the present general inventive concept may be achieved by providing a connector including a connector main body mounted on a circuit board, having a through hole formed to penetrate the connector main body, and having a rear end portion, and a plurality of pins provided in the connector main body to be soldered to the circuit board, the pins including first pins having soldering portions disposed to correspond to the through hole and second pins having soldering portions disposed to correspond to the rear end portion.

The connector may further include a connector cover disposed on the connector main body, having a soldering portion extended toward the circuit board to be coupled to the circuit board, and having a pin expose hole to correspond to the through hole such that the soldering portions of the first pins are exposed to and accessed from an outside of the connector cover.

The connector main body may further include a front end portion formed with a plug connection portion, and the though hole may be disposed between the front end portion and the rear end portion.

The second pins each may have a portion passing through the through hole, and the portions of the second pins and the first pins may be disposed in the through hole.

The through hole may penetrate the connector main body in a direction perpendicular to a direction in which horizontal portions of the pins run.

Portions of the first pins may be disposed at a first height and portions of the second pins may be disposed at a second height in the through hole.

The connector main body may further include a pin support portion formed between the through hole and the rear end portion, and the second pins may have portions disposed in the pin support portion.

The soldering portions of the first pins and the second pins may be disposed to protrude from the through hole and the rear end portion of the connector main body, respectively.

The foregoing and/or other features and utilities of the present general inventive concept may be achieved by providing an electronic apparatus including a circuit board and a connector main body mounted on the circuit board, having a through hole formed to penetrate the connector main body, having a rear end portion formed at one end of the connector main body, a front end portion formed at the other end of the connector main body, and having a plurality of pins provided in the connector main body to be soldered to the circuit board, the pins comprising first pins having soldering portions disposed in the through hole and second pins having soldering portions disposed in the rear end portion. The electronic device may further include a connector cover disposed on the connector main body, having a soldering portion extended toward the circuit to be coupled to the circuit board, and having a pin expose hole to correspond to the through hole such that the soldering portions of the first pins are exposed to and accessed from an outside of the connector cover.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a perspective view illustrating a connector according to an exemplary embodiment of the present general inventive concept;

FIG. 2 is a perspective view illustrating a connector main body of the connector of FIG. 1;

FIG. 3 is a cross-sectional view illustrating the connector taken along line III-III of FIG. 1;

FIG. 4 is a cross-sectional view illustrating a connector according to an exemplary embodiment of the present general inventive concept;

FIG. 5 is a plan view illustrating the connector of FIG. 1; and

FIG. 6 is a bottom view illustrating the connector of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

A connector is referred to as an electronic part configured to electrically connect a power and/or signal source to an apparatus, apparatuses, or one or more unit within an apparatus. The connector may be divided into various types according to a form and a connection method in which the connector is connected to a cable or mounted on a circuit board or printed circuit board PCB.

The exemplary embodiment will describe only a connector mounted on a PCB. Hereinafter, a connector according to an exemplary embodiment will be described with reference to the accompanying drawings.

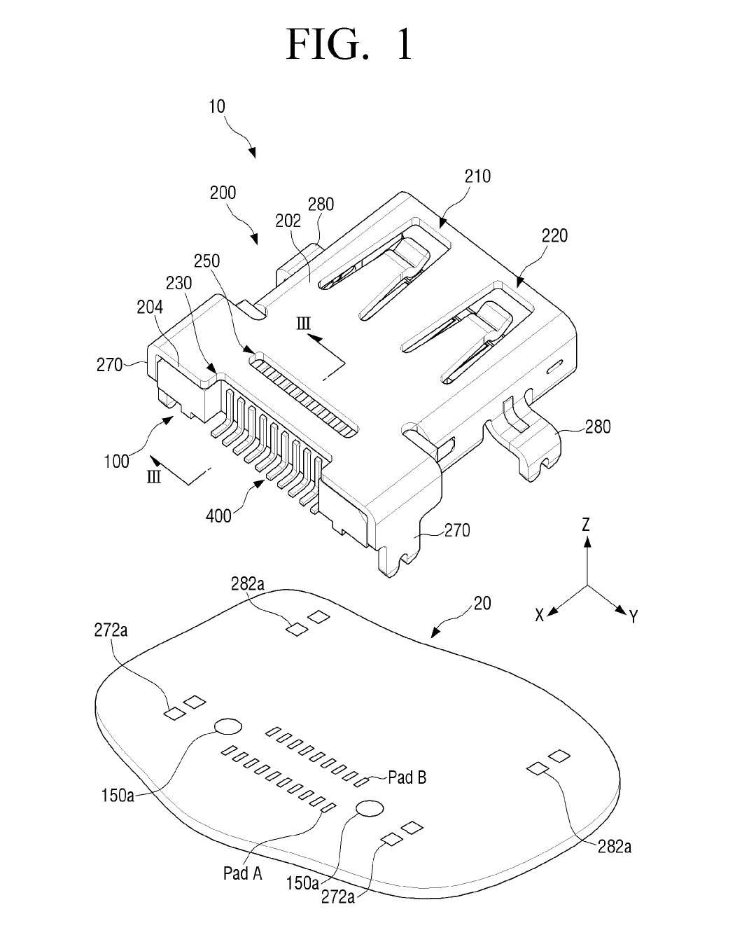

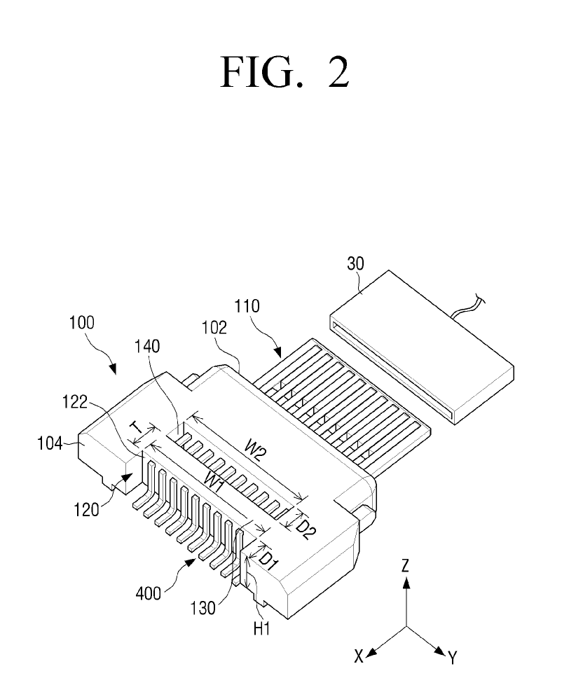

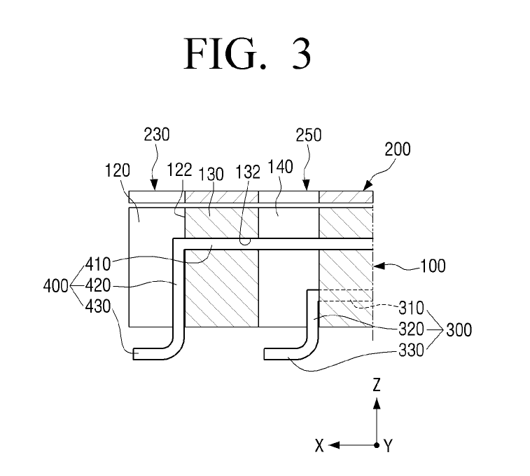

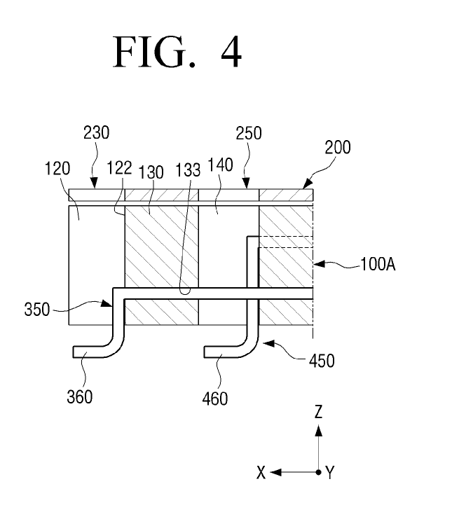

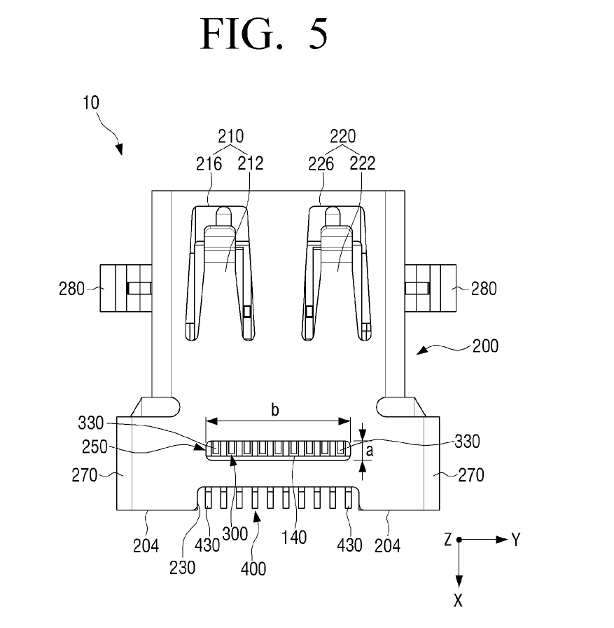

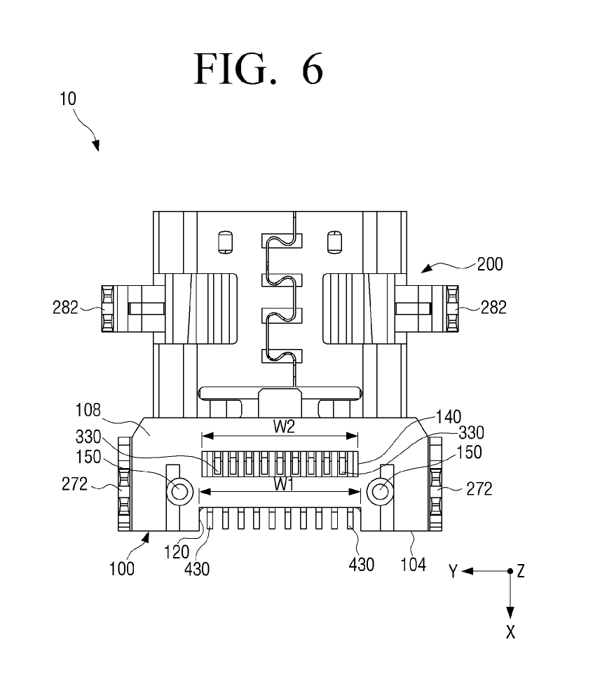

FIG. 1 illustrates a connector 10 of an electronic apparatus according to an exemplary embodiment of the present general inventive concept, FIG. 2 illustrates a connector main body 100 of the connector 10 of FIG. 1, FIG. 3 illustrates the connector 10 taken along line III-III of FIG. 1, FIG. 4 illustrates a connector according to an exemplary embodiment of the present general inventive concept, FIG. 5 is a plan view illustrating the connector of FIG. 1, and FIG. 6 is a bottom view illustrating the connector of FIG. 1.

Referring to FIGS. 1 through 6, a connector 10 is mounted on a board, for example, a PCB 20 and is a SMD type connector. The connector 10 includes a connector main body 100 (or 100A), a connector cover 200, and a plurality of pins 300 and 400 (or 350 and 450). The pins 300 and 400 (450 and 350) may be referred to as first pins and second pins, respectively. The pins 300 and 350 may be referred to as lower pins, and the pins 400 and 450 may be referred to as upper pins, respectively.

The connector main body 100 is mounted on the PCB 20. A plug 30 connected to an external apparatus or the like is detachably mounted on the connector main body 100. The connector main body 100 may have a plug connection portion 110, a rear end groove 120, a pin support portion 130, a through hole 140, and at least one insertion protrusion 150.

The plug connection portion 110 is formed to protrude from a front end portion 102 of the connector main body 100 toward a front direction (a −X-axis direction) of the connector main body 100. As described above, the plug connection portion 110 may be inserted into and connected to the plug 30 connected to (or extended from) an external apparatus or the like. However, this is merely exemplary, and the plug may 30 be inserted into the plug connection portion 110 such that one or more first terminals of the plug connection portion 110 are electrically connected to corresponding one or more second terminals of the plug 30. Here, the first terminals of the plug connection portion 110 are electrically connected to the corresponding pins 300 and 400 (or 350 and 450).

The rear end groove 120 is formed in a rear end portion 104 of the connector main body 100. The rear end groove 120 is formed along a width direction (a Y-axis direction) of the connector main body 100. The rear end groove may have a width W1, a height H1, and a depth D1. The plurality of upper pins 400 are exposed from a rear of the connector main body 100 through the rear end groove 120. That is, portions of the plurality of upper pins 400 are exposed from the rear end groove 120 to an outside of the connector 10 so that the plurality of upper pins 400 can be seen and accessed from the outside of the connector 10.

The pin support portion 130 is provided between the rear end groove 120 and the through hole 140. The pin support portion 130 may have a thickness T, and the rear end groove 120 and the though hole 140 are spaced apart from each other by the thickness T. The thickness T may not be variable along a Y-axis direction. However, the present general inventive concept is not limited thereto. It is possible that the thickness T may be variable along the Y-axis direction according to a user or design preference. The pin support portion 130 may include a plurality of pin through holes 132 through which corresponding portions of the upper pins 400 can pass. The pin support portion 130 fixedly holds the upper pins 400 and prevents the upper pins 400 from moving with respect to the connector main body 100.

The through hole 140 is formed to penetrate the connector main body 100 to a vertical direction (a Z-axis direction) so that the lower pins 300 may be exposed to an outside of the connector 10. The upper pins 400 may have first portions (upper horizontal portions) 410, second portions (upper vertical portions) 420, and third portions (upper pin soldering portions) 430 soldered on corresponding pads A of the PCB 20. The lower pins 300 may have first portions (lower horizontal portions) 310, second portions (lower vertical portions) 320, and third portions (lower pin soldering portions) 330 soldered on corresponding pads B of the PCB 20. When the connector 10 is mounted on and connected to the PCB 20, lower soldering portions 330 of the lower pins 300 may be exposed to and/or accessed from the outside of the connector 10 through the through hole 140.

The through hole 140 may have a rectangular bar-shaped cross-section. The through hole 140 has a width W2 sufficient in a Y-axis direction to expose the lower pin soldering portions 330 of the lower pins 300 as well as the first portions 410 of the upper pins 400. That is, the through hole 140 in the exemplary embodiment has the width W2 sufficient to also expose the first portions 410 of the upper pins 400 arranged in an outer side of the lower pin soldering portions 330 of the outermost lower pins 300. However, this is merely exemplary, and the through hole 140 may have a width sufficient to expose only all the lower pin soldering portions 330 of the lower pins 300. Further, the through hole 140 may have a depth D2 to have a size sufficient to expose the lower pin soldering portions 330 of the lower pins 300. When the connector main body 100 is viewed from a top thereof, the upper pins 400 and the lower pins 300 are alternately arranged in a Y-axis direction in the though hole 140. However, the present general inventive concept is not limited thereto. The upper pins 400 and the lower pins 300 may be arranged differently within the though hole 140. It is possible that the upper pins 400 are disposed in a first space of the though hole 140 and the lower pins 300 are disposed in a second space of the though hole 140.

Although FIG. 2 illustrates the connector main body 100 to have the pin support portion 130 and the though hole 140, the present general inventive concept is not limited thereto. A connector main body may have a structure having no pin support portion and through hole. The connector main body may have a structure that may be covered by the connector cover 200 so that the lower pin soldering portions 330 of the lower pins 300 can be exposed through a pin expose hole 250 of the connector cover 200 which will be described later. For example, the connector main body may have a structure having a U-shaped groove which may receive or accommodate the plurality of pins 300 and 400 when viewed in the rear direction (the +X-axis direction), or a structure which exposes only the plurality of pins 300 and 400 when viewed in the rear direction (the +X-axis direction).

The insertion protrusion 150 is configured to guide mounting of the connector main body 100 when the connector main body 100 is mounted on a portion 150a of the PCB 20. The insertion protrusion 150 is formed to protrude from a bottom 108 of the connector main body 100. The insertion protrusion 150 may penetrate the PCB 20, and at least one protrusion 150 may be provided. The connector main body 100 may have a pair of insertion protrusions 150 spaced apart from each other as illustrated in FIG. 6. However, the number of the insertion protrusions 150 and a location of the insertion protrusions 150 may be changed according to a user or design preference. A coupling of the insertion protrusion 150 of the connector main body 100 and the portion 150a of the PCB 20 may prevent the connector main body 100 from moving with respect to the PCB 20.

The connector cover 200 covers the connector main body 100 and simultaneously fixes the connector main body 100 to the PCB 20. The connector cover 200 may include a pair of elastic portions 210 and 220, an expose groove 230, the pin expose hole 250, and a plurality of cover soldering portions 270 and 280.

The pair of elastic portions 210 and 220 guide a connection between the plug connection portion 110 and a plug 30. The pair of elastic portions 210 and 220 stably fix the plug 30 connected to the plug connection portion 110 to the connector main body 100 when the plug 30 is mounted (or attached), and the pair of elastic portions 210 and 220 may guide detachment of the plug 30 from the plug connection portion 110 when the plug 30 is detached.

The pair of elastic portions 210 and 220 includes a first elastic portion 210 and a second elastic portion 220.

The first elastic portion 210 includes a first elastic contact protrusion 212 and a first guide groove 216.

The first elastic contact protrusion 212 elastically moves in a vertical direction (the Z-axis direction) of the connector cover 200, and the first elastic contact protrusion 212 is snap-fit to a portion of the plug 30 and fixes the plug 30 to the connector main body 100 when the plug 30 is mounted.

The first guide groove 216 is formed to enclose or accommodate the first elastic contact protrusion 212 in a top 202 of the connector cover 200 so that the first elastic contact protrusion 212 can be movable in a vertical direction (the Z-axis direction) of the first elastic contact protrusion 212.

The second elastic portion 220 includes a second elastic contact protrusion 222 and a second guide groove 226.

The second elastic contact protrusion 222 is arranged to be spaced apart from the first elastic contact protrusion 212. The second elastic contact protrusion 222 may have the same shape and function as the first elastic contact protrusion 212, and thus detailed description thereof will be omitted.

The second guide groove 226 is arranged to be spaced apart from the first guide groove 216. The second guide groove 226 has the same shape and function as the first guide groove 216, and thus detailed description thereof will be omitted.

The expose groove 230 is formed in a rear end portion 204 of the connector cover 200. The expose groove 230 is arranged to correspond to an upper side of the rear end groove 120 and has a shape corresponding to the rear end groove 120 of the connector main body 100 so that the plurality of upper pins 400 may be exposed to the outside of the connector 10 through the exposed groove 230 and the rear end groove 120.

The pin expose hole 250 is formed in a top portion 202 of the connector cover 200 and disposed to be spaced apart from the expose groove 230 in a front direction (the −X-axis direction). The pin expose hole 250 is formed along a width direction (the Y-axis direction) of the connector cover 200, and the pin expose hole 250 is formed in an upper side of the through hole 140 so that the lower pin soldering portions 330 of the lower pins 300 may be exposed to the outside of the connector 10 through the pin expose hole 250 and the through hole 140.

As illustrated in FIG. 5, the pin expose hole 250 may have a depth a in the X-axis direction to have a size sufficient to expose or access all the lower pin soldering portions 330 of the lower pins 300. That is, the depth a of the pin expose hole 250 in the X-axis direction may be longer than a length of each lower pin soldering portion 330 in the X-axis direction.

Also as illustrated in FIG. 5, the pin expose hole 250 may have a width b in the Y-axis direction to provide a size sufficient to expose or access all the lower pin soldering portions 330 of the lower pins 300. That is, the width b of the pin expose hole 250 in the Y-axis direction may be larger than a space (distance) between the lower pin soldering portions 330 of the outermost lower pins 300.

The pin expose hole 250 may be formed to be equal to or larger than the through hole 140. However, when the lower pin soldering portions 330 of the lower pins 300 are exposed to or accessed from the outside of the connector 10, the size of the pin expose hole 250 may be smaller than that of the through hole 140.

In the exemplary embodiment, a user may easily check the lower pin soldering portions 330 of the lower pins 300 in the naked eye through the pin expose hole 250 formed in the connector cover 200 and the upper pin soldering portions 430 of the upper pins 400 which are exposed to the outside of the connector 10.

Therefore, the user may easily check a soldering state of the plurality of pins 300 and 400 and easily check a connection failure, a defect, or the like of the connector 10.

When the connector 10 is replaced due to the connection failure of the connector 10, soldering is released (or removed) by applying heat to a soldering portion of the connector 10. According to an embodiment of the present general inventive concept, the connector 10 provides a path to access the lower pin soldering portions 330 of the lower pins 300 for the release of the soldering in the lower pin soldering portions 330 of the lower pins 300.

In the exemplary embodiment, since the lower pin soldering portions 330 of the lower pins 300 are arranged below the pin expose hole 250 and are open to the outside of the connector 10 through the pin expose hole 250 of the connector cover 200, even when heat is applied from an upper side of the pin expose hole 250, the heat is easily transferred to the lower pin soldering portions 330 of the lower pins 300 through the pin exposed hole 250.

Therefore, in the exemplary embodiment, the soldering of the lower pin soldering portions 330 may be easily released even without increase in a temperature of the heat more than necessary to release the soldering. Thus, in the exemplary embodiment, the PCB 20 is prevented from being damaged due to a high temperature applied for the soldering release.

The connector cover 200 may have one or more coupling elements to couple (attach or fix) the connector cover 200 to the PCB 20, such as a plurality of cover soldering portions 270 and 280. The cover soldering portions 270 and 280 may be soldered to the PCB 20 so that the connector main body 100 may be stably fixed to the PCB 20. The cover soldering portions 270 and 280 may be referred to as a pair of rear end soldering portions 270 and a pair of side end soldering portions 280.

The pair of rear end soldering portions 270 are formed in opposite side portions of the rear end portion 204 of the connector cover 200. A rear end soldering protrusion 272 is formed to protrude from a bottom of each rear end soldering portion 270 to be soldered to a corresponding portion 272a of the PCB 20.

The pair of rear end soldering portions 270 are soldered to the PCB 20 in opposite side portions of the rear end portion 204 of the connector cover 200. Therefore, the connector cover 200 may cover the rear end portion 104 of the connector main body 100 and simultaneously the connector cover 200 may be fixed to the PCB 20.

The pair of side end soldering portions 280 are provided in opposite side portions of the connector cover 200. Each side end soldering portion 280 is formed to be spaced apart from each rear end soldering portion 270 to the front (the −X-axis direction) of the connector cover 200. A side end soldering protrusion 282 is formed to protrude in a bottom of each side end soldering portion 280 to be soldered to a corresponding portion 282a of the PCB.

The pair of side end soldering portions 280 are formed to protrude more outward from a side portion of the connector cover 200 than the pair of rear side soldering portions 270 in the width direction (the Y-axis direction) of the connector cover 200. Therefore, the connector cover 200 may provide four columns of soldering points when viewed in a length direction (the X-axis direction) of the connector cover 200, that is, when viewed in a front and rear direction (the X-axis direction). Therefore, the connector cover 200 according to the exemplary embodiment may be stably fixed to the PCB 20. A first distance between the side end soldering protrusions 282 of the side end soldering portions 280 may be longer than a second distance between the rear end soldering protrusions 272 of the rear end soldering portions 270. The first distance and the second distance are longer than the width b of the pin expose hole 250. The rear end soldering portions 270 are extended from a side portion of the connector cover 200 in the Z-axis direction toward the PCB 20, and the side end soldering portions 280 may have a first portion to be extended from a side portion of the connector cover 200 in the Y-axis direction and a second portion extended from an end of the first portion in the Z-axis direction toward the PCB 20.

In addition, the connector cover 200 according to the exemplary embodiment may efficiently absorb a load applied to connector main body 100 according to a movement or a mounting or detaching process of the plug 30 with respect to the connector 10 in a front and rear direction (the X-axis direction) of the connector 10 through the pair of rear end soldering portions 270 and the pair of side end soldering portions 280.

Therefore, the connector 10 according to the exemplary embodiment may efficiently prevent crack of the plurality of pins 300 and 400 since the transfer of the load to the pins 300 and 400 soldered to the PCB 20 according to a movement thereof is minimized.

The plurality of pins 300 and 400 are provided in the connector main body 100 to be electrically connected to the plug connection portion 110. The plurality of pins 300 and 400 are respectively soldered to the corresponding pads A and B of the PCB 20 to electrically connect the PCB 20 and an external apparatus or the like through the plug 30.

The plurality of pins 300 and 400 are arranged in at least two different columns disposed at different heights from a bottom of the connector main body 110 so that a size (dimension) of the connector 10 in the width direction (the Y-axis direction) of the connector 10 is not increased due to an arrangement of the pins. The exemplary embodiment has described that the pins 300 and 400 are provided only in two columns vertically arranged. For example, as illustrated in FIG. 3, the upper horizontal portions 410 of the upper pins 400 are arranged (disposed) in the Y-axis direction at a first column disposed at a first height from the bottom, and the lower horizontal portions 310 of the lower pins 300 are arranged (disposed) in the Y-axis direction at a second column disposed at a second height from the bottom. However, the present general inventive concept is not limited thereto. It is possible that the pins may be arranged in three columns. In this case, the connector cover may have two pin exposed holes in addition to an exposed groove and the connector main body may have two through holes in addition to a rear end groove so that soldering portions of the pins disposed in the through holes can be exposed to and accessed from an outside of the connector.

The plurality of lower pins 300 and the plurality of upper pins 400 may be alternately arranged along the width direction (the Y-axis direction) of the connector main body 100. That is, one lower pin 300 is arranged between two upper pins 400. The first portions of the upper pins 400 and the first portions of the lower pins 300 are disposed to be separated by a distance in the Z-axis direction.

The plurality of pins 300 and 400 in the exemplary embodiment include a total of 19 pins, that is, nine (9) lower pins 300 and ten (10) upper pins 400. However, this is merely exemplary, and the number of pins may be variously changed according to a user or design preference.

The plurality of lower pins 300 are electrically connected to the plug connection portion 110 and are soldered to the PCB 20. The lower pins 300 are arranged to be spaced apart from each other in the width direction (the Y-axis direction) of the connector main body 100. As stated above, each lower pin 300 includes the first portion (lower horizontal portion) 310, the second portion (lower vertical portion) 320, and the third portion (lower pin soldering portion) 330 as stated above.

The lower horizontal portion 310 is connected to the plug connection portion 110 and extends within the connector main body 100 to a rear portion of the connector main body 100 in a +X-axis direction.

The lower vertical portion 320 extends from the lower horizontal portion 310 to a bottom portion of the connector main body 100 in a −Z-axis direction. The lower vertical portion 320 is supported by an inner wall of the connector main body 100 within the through hole 140.

The lower pin soldering portion 330 is bent in the +X-axis direction toward the rear portion of the connector main body 100 from the lower vertical portion 320 to a horizontal direction. The lower pin soldering portion 330 is soldered to the corresponding pads of the PCB 20, and exposed to an outside of the connector 10 through the through hole 140 of the connector main body 100 and the pin expose hole 250 of the connector cover 200.

The plurality of upper pins 400 are electrically connected to the plug connection portion 110 and are soldered to the PCB in a similar process to the lower pins 300. The upper pins 400 are arranged to be spaced apart from each other in the width direction (the Y-axis direction) of the connector main body 100. As stated above, each upper pin 400 includes the first portion (upper horizontal portion) 410, the second portion (upper vertical portion) 420, and the third portion (upper pin soldering portion) 430.

The upper horizontal portion 410 is connected to the plug connection portion 110. The upper horizontal portion 410 penetrates the connector main body 100 and extends in the connector main body 100 to the rear portion of the connector main body 100 in the X-axis direction. Here, a portion of the upper horizontal portion 410 is disposed to pass through the pin through hole 132 of the pin support portion 130. It is possible that the portion of the upper horizontal portion 410 may be disposed to pass through a side body portion of the connector main body 100 other than the through hole 140.

The upper vertical portion 420 extends from the upper horizontal portion 410 to a bottom portion of the connector 10 in the Z-axis direction. The upper vertical portion 420 is supported to an inner wall 122 of the rear end groove 120, and exposed through the rear end groove 120 of the connector main body 100 and the expose groove 230 of the connector cover 200 in a rear portion of the connector 10 in the +X-axis direction.

The upper pin soldering portion 430 is bent in the +X-axis direction toward the rear portion of the connector main body 100 from the upper vertical portion 420 to the horizontal direction. The upper pin soldering portion 430 is soldered to the corresponding pad of the PCB 20, and exposed to the outside of the connector 10 through the rear end groove 120 of the connector main body 100 and the expose groove 230 of the connector cover 200.

The plurality of upper pins 400 according to the exemplary embodiment are stably fixed to the connector main body 100 through the upper horizontal portions 410 passing through the pin through holes 132 and the upper vertical portions 420 supported by or disposed on the inner wall 122 of the rear end groove 120.

Thus, even when the plurality of upper pins 400 may further extend to the rear portion of the connector main body 100 in the +X-axis direction rather than the plurality of lower pins 300, the plurality of upper pins 400 may ensure a stable fixing force.

FIG. 4 illustrates a connector main body 100A according to an embodiment of the present general inventive concept. The connector main body 100A may have a plurality of pins 350 and 450 having different structures of the pins 300 and 400 of FIG. 3. The lower pins 350 may be exposed in a rear end groove 120 of the connector main body 100A and an exposed groove 230 of the connector cover 200, and upper pins 450 may be exposed in a through hole 140 of the connector main body 100A and a pin expose hole 250 of the connector cover 200. That is, lower pin soldering portions 360 of the lower pins 350 may be arranged to the rear direction (+X-axis direction) to be disposed in the rear end groove 120, and upper pin soldering portions 460 of the upper pins 450 may be arranged to be disposed in the through hole 140.

In the exemplary embodiment, since the lower pins 350 are exposed in the rear end groove 120, a pin through hole 133 of a pin support portion 130 is formed in a lower side of the connector main body 100A. The plurality of lower pins 350 are stably fixed to the connector main body 100A through the pin through hole 133 of the pin support portion 130. It is possible that a portion of an lower horizontal portion of the lower pins 350 may be disposed to pass through the through hole 140 at a lower position than an upper horizontal portion of the upper pin 450. It is possible that the portion of the lower horizontal portion of the lower pins 350 may be disposed to pass through a side body portion of the connector main body 100A other than the through hole 140.

Thus, the plurality of lower pins 350 may ensure a stable fixing force even when the plurality of lower pins 350 further extend to the rear portion (+X-axis direction) of the connector main body 100A rather than the plurality of upper pins 450.

According to an embodiment of the present general inventive concept, a connector may include a connector main body mounted on a circuit board, having a through hole formed to penetrate the connector main body, and having a rear end portion. The connector may further include a plurality of pins provided in the connector main body to be soldered to the circuit board, the pins comprising first pins having soldering portions disposed in the through hole and second pins having soldering portions disposed in the rear end portion. The connector may further include a connector cover disposed on the connector main body, having a soldering portion to be coupled to the circuit board, and having a pin expose hole to correspond to the through hole such that the soldering portions of the first pins are exposed to and accessed from an outside of the connector cover.

According to an embodiment of the present general inventive concept, the connector 10 and the PCB 20 as a circuit board may be included in an electronic apparatus or device as illustrated in FIGS. 1-6. That is, FIG. 1 illustrates the electronic device including the connector 10 and the PCB 20. The electronic device may include other units to perform its functions. However, other units are well known, and thus detail descriptions thereof will be omitted. The electronic device may include a circuit board and a connector main body mounted on the circuit board, having a through hole formed to penetrate the connector main body, having a rear end portion formed at one end of the connector main body, having a front end portion formed at the other end of the connector main body, and also having a plurality of pins provided in the connector main body to be soldered to the circuit board, the pins comprising first pins having soldering portions disposed in the through hole and second pins having soldering portions disposed in the rear end portion. The electronic device may also include a connector cover disposed on the connector main body, having a soldering portion extended toward the circuit board to be coupled to the circuit board, and having a pin expose hole to correspond to the through hole such that the soldering portions of the first pins are exposed to and accessed from an outside of the connector cover.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A connector comprising:
a connector main body mounted on a printed circuit board (PCB);
a plurality of pins provided in the connector main body, and vertically arranged in at least two columns; and
a connector cover configured to fix the connector main body to the PCB and have a pin expose hole configured to expose soldering portions of pins in at least one column among the plurality of pins.

2. The connector of claim 1, wherein the plurality of pins include:
lower pins having soldering portions exposed through the pin expose hole; and
upper pins arranged at an upper side of the lower pins.

3. The connector of claim 2, wherein soldering portions of the upper pins are exposed to a rear portion of the connector cover.

4. The connector of claim 1, wherein the plurality of pins include:
upper pins having soldering portions exposed through the pin expose hole; and
lower pins arranged at a lower side of the upper pins.

5. The connector of claim 4, wherein soldering portions of the lower pins are exposed to a rear portion of the connector cover.

6. The connector of claim 1, wherein the connector main body comprises a through hole arranged in a lower side of the pin expose hole to expose the soldering portions of the pins in the at least one column among the plurality of pins, and formed to penetrate the connector main body.

7. The connector of claim 1, wherein the connector cover includes a plurality of cover soldering portions to be soldered to the PCB.

8. The connector of claim 7, wherein the plurality of cover soldering portions include:
a pair of rear end soldering portions provided in opposite side portions of a rear end portion of the connector cover; and
a pair of side end soldering portions spaced apart from the pair of rear end soldering portions to a front of the connector cover, and provided in opposite side portions of the connector cover.

9. The connector of claim 8, wherein the pair of side end soldering portions protrude along a width direction of the connector cover, and protrude in the width direction of the connector cover by a length longer than the pair of rear end soldering portions.

10. The connector of claim 1, wherein the pins arranged in different columns are alternately arranged along a width direction of the connector main body.

11. The connector of claim 1, wherein the connector is a surface mounted device (SMD) type connector.

12. A connector comprising:
a connector main body mounted on a circuit board, having a through hole formed to penetrate the connector main body, and having a rear end portion; and
a plurality of pins provided in the connector main body to be soldered to the circuit board, the pins comprising first pins having soldering portions disposed to correspond to the through hole and second pins having soldering portions disposed to correspond to the rear end portion.

13. The connector of claim 12, further comprising:
a connector cover disposed on the connector main body, having a soldering portion extended toward the circuit board to be coupled to the circuit board, and having a pin expose hole to correspond to the through hole such that the soldering portions of the first pins are exposed to and accessed from an outside of the connector cover.

14. The connector of claim 12, wherein the connector main body comprises a front end portion formed with a plug connection portion, and the though hole is disposed between the front end portion and the rear end portion.

15. The connector of claim 12, wherein the second pins each have a portion passing through the through hole such that the portions of the second pins and the first pins are disposed in the through hole.

16. The connector of claim 12, wherein the through hole penetrates the connector main body in a direction perpendicular to a direction in which horizontal portions of the pins run.

17. The connector of claim 12, wherein portions of the first pins are disposed at a first height and portions of the second pins are disposed at a second height in the through hole.

18. The connector of claim 12, wherein the connector main body comprises a pin support portion formed between the through hole and the rear end portion, and the second pins have portions disposed in the pin support portion.

19. The connector of claim 12, wherein the soldering portions of the first pins and the second pins are disposed to protrude from the through hole and the rear end portion of the connector main body, respectively.

20. An electronic apparatus comprising:
a circuit board;
a connector main body mounted on the circuit board, having a through hole formed to penetrate the connector main body, having a rear end portion formed at one end of the connector main body, a front end portion formed at the other end of the connector main body, and having a plurality of pins provided in the connector main body to be soldered to the circuit board, the pins comprising first pins having soldering portions disposed in the through hole and second pins having soldering portions disposed in the rear end portion; and
a connector cover disposed on the connector main body, having a soldering portion extended toward the circuit to be coupled to the circuit board, and having a pin expose hole to correspond to the through hole such that the soldering portions of the first pins are exposed to and accessed from an outside of the connector cover.
